(19) United States
(12) Patent Application Publication
(10) Pub. No.: US 2009/0252830 A1
(43) Pub. Date: Oct. 8, 2009

(54) Process of producing probiotic enhanced brown rice bran nutritional suppliment to promote increased levels of intestinal flora

(76) Inventor: William Baik, Rowland Heights, CA (US)

Correspondence Address: Eugene Oak, 610 South Van Ness Avenue, Los Angeles, CA, 90005, US

(21) Appl. No.: 12/080,375

(22) Filed: Apr. 2, 2008

(51) Int. Cl. A23L 1/105

(52) U.S. Cl. 426/31

(57) ABSTRACT

The present invention is a pulverized fiber composition manufactured through fermentation of Brown Rice Bran with Lactobacillus Bulgaricus bacteria, which is enhanced with Bifidus and Acidophilus, resulting in a cereal with beneficial health properties; where, the fiber can be used as a natural dietary supplement and medicaments for the treatment and prevention of Gastrointestinal disorder, yeast infection, skin disorder, and hair thinning by boosting levels of beneficial intestinal flora which aid in digestion and boosts the human immune system.

### BACKGROUND OF THE INVENTION

By fermenting Brown Rice Bran with the addition of Dry Evaporated Milk, with the subsequent of Lactobacillus Bulgaricus, Bifidus, and Acidophilus, the beneficial micro nutrients are retained from the Brown Rice Bran, and fortified and beneficial antioxidant vitamin extracts and cultured yogurt.

The fermentation process breaks down the Brown Rice Bran into smaller water-soluble molecules. The Dry Evaporated Milk used as the fermentation culture medium has a high rate of survival at high temperatures. This reduces the need highly controlled production supervision as the fermentation progresses over time, which is typically 48 to 72 hours depending on the temperature and humidity of the environmental surroundings. The fermentation is regulated by a heat humidity ratio. Fermentation breaks up the large molecules of the Brown Rice Bran; thereby, separating macromolecular structure of the Brown Rice Bran. The Brown Rice Bran which remains and is separated from micronutrient residue during the fermentation process can be used as a pulverized meal additive, and can be added to food preparations, or consumed as gruel, providing health benefits to foods, or used as a vitamin supplement.

Rice Bran is a by-product of the rice milling process, and it contains various antioxidants that impart beneficial effects on human health. It is well known that a major Rice Bran fraction contains oil and highly unsaponifiable components. The unsaponifiable components of Rice Bran contribute to the lowering of the plasma levels of the various parameters of the lipid profile in the body. Rice Bran also contains a high level of dietary fiber. The Rice Bran is fermented with three Probiotic bacteria: Lactobacillus Bulgaricus, Acidophilus, and Bifidus;

where:

Lactobacillus Bulgaricus is one of several bacteria used for the production of yogurt. It has complex nutritional requirements, including the inability to ferment any sugar except for lactose.

This bacterium is also regarded as Aciduric or Acidphilic; due to the fact that it requires a relatively low pH in order to grow effectively.

Acidophilus occurs naturally in the human and animal gastrointestinal tract, mouth, and vagina. The acid produced by Acidophilus in the vagina helps to control the growth of the fungus, A dietary supplement which includes Acidophilus is used to prevent vaginal yeast infections, and oral or gastrointestinal infections.

Bifidus specifically enhances the growth of Bifidobacteria in either a product or in the intestines of humans and/or animals. The Bifidobacteria population is influenced by a number of factors, including diet, antibiotics and stress. Bifidus assists in maintaining healthy levels of intestinal flora which aids in digestion and boosts the immune system deliver extra intestinal flora to the gut. Bifidus will engender temporary colonies of bacteria which catalyzes the body's natural flora.

The resultant fibrous cereal is as a Probiotic food supplement; where, different flavoring agents may be added, such as cocoa, in order for the substance to be consumed by the individual strictly as a supplement or added to enrich food preparations thereby providing the body with beneficial bacteria to assist in digestion and supplement the body's immune system.

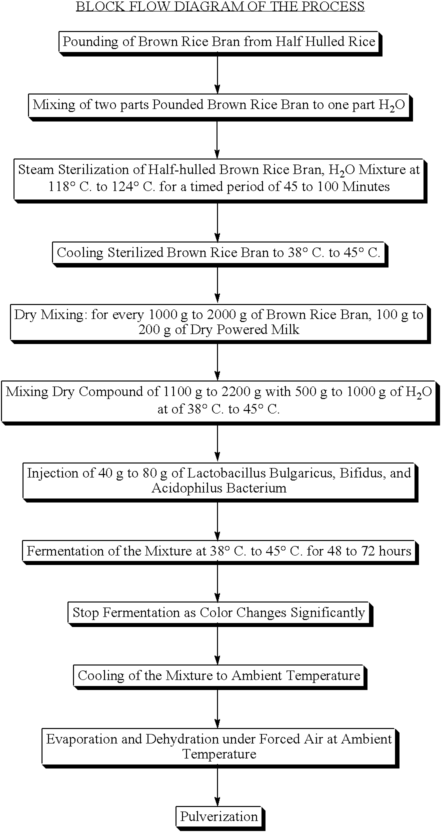

### DETAILED DESCRIPTION OF THE PROCESS

The dry Brown Rice Bran is pounded; then, combined in a two parts Pounded Brown Rice Bran to one part H₂O mixture; and, subsequently steam sterilized at a controlled temperature of 118° C. to 124° C. between 45 to 100 minutes at atmospheric pressure, then cooled to 38° C. to 45° C.; after cooling, for every 1000 g to 2000 g of Brown Rice Bran, 100 g to 200 g of Powered Milk is dry mixed thoroughly, then the dry compound of roughly 1100 g to 2200 g is mixed with 500 g to 1000 g of H₂O at a temperature of 38° C. to 45° C.; 40 g of each Lactobacillus Bulgaricus, Bifidus, and Acidophilus bacteria are added to the mixture in preparation for fermentation; where, the mixture is then fermented at a temperature of 38° C. to 45° C. for 48 to 72 hours; where, the indicator that the fermentation is complete is signaled by a significant color change; then, the compound is cooled to an ambient temperature of 18° C. to 24° C., dehydrated under forced air at the ambient temperature; then, pulverized into a cereal.

What is claimed is:

1. A method of producing a nutrient food from Brown Rice Bran prepared through fermentation where the dry Brown Rice Bran is pounded, then combined in a two parts Pounded Brown Rice Bran to one part H₂O mixture, then steam sterilized, then cooled; after cooling, for every 1000 g to 2000 g of Brown Rice Bran, 100 g to 200 g of Powered Milk is dry mixed thoroughly, then the dry compound of roughly 1100 g to 2200 g is mixed with 500 g to 1000 g of H₂O; 40 g to 80 g of each Lactobacillus Bulgaricus, Bifidus, and Acidophilus bacteria are added to the mixture in preparation for fermentation; where, the mixture is then fermented; where, the indicator that the fermentation is complete is signaled by a significant color change; and, the compound is cooled to an ambient temperature of 18° C. to 24° C., the H₂O is evaporated and the nutrient food is dehydrated under forced air at the ambient temperature; then, pulverized into a nutrient cereal for human consumption.

2. The method in accordance with claim 1, where the steam sterilization step is controlled at a temperature of 118° C. to 124° C. between 45 to 100 minutes at the atmospheric pressure.

3. The method in accordance with claim 1, where the cooling after steam sterilization step is controlled to a temperature of 38° C. to 45° C.

4. The method in accordance with claim 1, where the mixture in preparation for fermentation is comprised of Dry Powered Milk, Lactobacillus Bulgaricus, Bifidus, and Acidophilus bacterium, and is fermented at a temperature of 38° C. to 45° C. for 48 to 72 hours.

5. The method in accordance with claim 1, where the compound is cooled to ambient temperature of 18° C. to 24° C., and let stand evaporate and dehydrate under forced air at ambient temperature in preparation for pulverization into a nutrient cereal for a human consumption.
